(19) United States
(12) Patent Application Publication
(10) Pub. No.: US 2007/0020010 A1
(43) Pub. Date: Jan. 25, 2007

(54) Ink ribbon cassette

(75) Inventors: Takahito Maruyama, Fukushima-ken (JP); Yoshibumi Abe, Fukushima-ken (JP); Zenko Motoki, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/486,775

(22) Filed: Jul. 14, 2006

(30) Foreign Application Priority Data
Jul. 21, 2005 (JP) 2005-210998

(51) Int. Cl. B41J 17/32

(52) U.S. Cl. 400/208

(57) ABSTRACT

An ink ribbon cassette is provided. The ink ribbon cassette includes a ribbon outlet provided near a first ribbon-receiving part of an ink ribbon cassette of the invention in a head insertion opening. A ribbon winding opening is provided near a second ribbon-receiving part in the head insertion opening. A first paper guide is provided at the ribbon outlet and a second paper guide is provided at the ribbon winding opening so that a recording paper to be fed is guided by the first and second paper guides.

This application claims benefit of Japanese Patent Application 2005-210998 filed on Jul. 21, 2005 which is hereby incorporated by reference.

### BACKGROUND

1. Field

An ink ribbon cassette is provided.

2. Related Art

A conventional ink ribbon cassette (not shown) is mounted in a printer body 30 of a thermal transfer printer. An unused ink ribbon 31 is wound on a feeding reel 32 shown on the left side in FIG. 3. The unused ink ribbon is drawn from the feeding reel 32 through between a thermal head 34 and a platen roller 40 to be described below, and then wound on a take-up reel 33 shown on the right side in FIG. 3.

The thermal head 34, which draws the ink ribbon 31 wound on the feeding reel 32, is mounted to a bracket 35. The bracket 35 is mounted to a printer body 30 with a spring 36 interposed therebetween so that the thermal head can move up and down.

The thermal head 34 is disposed between a first and second feed rollers 38 and 39, which can press a recording paper 37 therebetween and feed the recording paper to the right side (downstream) or to the left side (upstream) in FIG. 3. A first and second press rollers 38a and 39a, which are elastically pressed against the first and second feed rollers 38 and 39, respectively, are disposed on the upper side of the first and second feed rollers 38 and 39 such that the recording paper 37 is pressed between the first and second press rollers and the first and second feed rollers.

A platen roller 40 is rotatably provided below the thermal head 34 so as to face the thermal head 34, and a paper detecting sensor 41 is positioned close to the first feed roller 38 between the platen roller 40 and the first feed roller 38.

The paper detecting sensor 41 has a structure in which a contacting element 41b is supported and swung on a base 41a. When the front end of the recording paper 37, which is fed to the downstream of the first feed roller 38 and the first press roller 38a, pushes down the contacting element 41b, the paper detecting sensor can detect that the front end of the recording paper 37 has passed.

In this way, the front end of the recording paper 37 is advanced. The recording paper is pressed and held between the first feed roller 38 and the first press roller 38a, and is fed to the downstream. The front end of the recording paper 37 can be pressed and held between the thermal head 34, which is in a head up state, and the platen roller 40.

In a first printing operation, when the recording paper 37 is pressed and held between the platen roller 40 and the thermal head 34, the recording paper is fed to the downstream. A first color ink is thermally transferred onto the entire recording paper 37 □ from the front end thereof to the rear end thereof. After that, the recording paper 37 on which a first color image is printed is pressed between the second feed roller 39 and the press roller 39a.

The thermal head 34 moves up against the elastic force of the spring 36. When the second feed roller 39 is rotated in a counterclockwise direction, the recording paper 37, which is pressed and held between the second feed roller 39 and the press roller 39a and has the first color image printed thereon, is back fed to the left side (upstream) in FIG. 3 through between the thermal head 34, which is in the head up state, and the platen roller 40.

The rear end of the recording paper 37 to be back fed to the upstream pushes down the contacting element 41b of the paper detecting sensor 41 to the left side, and is pressed and held between the first feed roller 38 and the first press roller 38a. When the first feed roller 38 is rotated in the counterclockwise direction, the recording paper is further back fed to the upstream.

When the contacting element 41b of the paper detecting sensor 41 escapes from the front end of the recording paper 37 such that the contacting element vertically stands, the front end of the recording paper 37 is advanced and the first feed roller 38 then stops not to be rotated.

The same operation as the first printing operation is repeated such that a second color image is overprinted on the first color image by performing a second printing operation.

It is possible to print a desired color image on the recording paper 37 by overprinting a third color image on the second color image.

The above-mentioned conventional ink ribbon cassette is disclosed in JP-A-8-72335.

When the conventional ink ribbon cassette (not shown) is mounted in the printer body 30 and the ink of the ink ribbon 31 is overprinted on the recording paper 37 to print a color image, the recording paper 37 is bent (in particular, upward) due to the heat or contact pressure of the thermal head 34.

Due to the bend of the recording paper 37, the timing in which the front end of the recording paper 37 to be fed to the downstream during printing is nipped by the second press roller is deviated due to the bend of the recording paper 37, and the front end of the recording paper 37 to be back fed cannot be detected with high accuracy by the contacting element 41b of the paper detecting sensor 41. For this reason, different colors of the ink ribbon 31 to be overprinted on the recording paper 37 are not overlapped with one another with high accuracy. Therefore, there is an undesirable possibility that a poor image is printed on the recording paper.

### SUMMARY OF THE INVENTION

An ink ribbon cassette is provided. According to a preferred embodiment, an ink ribbon cassette includes a first ribbon-receiving part that receives a feeding reel on which an unused ink ribbon is wound, and a second ribbon-receiving part for receiving a take-up reel on which a used ink ribbon is wound. In this case, a head insertion opening, into which a thermal head is inserted, is formed between the first and second ribbon-receiving parts. The thermal head approaches and is separated from (head up/down) a platen roller provided to a printer body. A ribbon outlet, through which the ink ribbon wound on the feeding reel passes, is provided near the first ribbon-receiving part in the head insertion opening. A ribbon winding opening, through which the ink ribbon drawn through the ribbon outlet passes to be wound on the take-up reel, is provided near the second ribbon-receiving part in the head insertion opening, and a first paper guide is provided at the ribbon outlet and a second paper guide is provided at the ribbon winding opening so that a recording paper to be fed is guided by the first and second paper guides.

According to another preferred embodiment, in the above-mentioned structure, the recording paper is disposed between the platen roller and the thermal head, which are provided to the printer body, so as to be fed in a direction in which the ink ribbon is wound, or in the reverse direction. When the ink ribbon cassette is mounted in the printer body and the thermal head moves down and the recording paper is printed while being fed to the downstream, the front end of the recording paper is guided by the second paper guide. When the thermal head moves up and the recording paper is back fed to the upstream, the rear end of the recording paper is guided by the first paper guide.

According to another preferred embodiment, in the above-mentioned structure, when the ink ribbon cassette is mounted in the printer body, a first paper feed roller and a first press roller, which press the recording paper therebetween and feed the recording paper between the platen roller and the thermal head, are provided near the first paper guide, and a second paper feed roller and a second press roller are provided near the second paper guide such that the recording paper is fed to the upstream or downstream by the rotation of the first and second paper feed rollers.

According to another preferred embodiment, in the above-mentioned structure, while being guided by the second paper guide, the front end of the recording paper, which is fed to the downstream during printing, is pressed and held by the second paper feed roller and the second press roller therebetween.

According to another preferred embodiment, in the above-mentioned structure, the recording paper, which is guided by the first and second paper guide, is fed in the flat shape.

According to a preferred embodiment, the ink ribbon cassette guides a recording paper during printing by paper guides to reduce the deviation of the timing in which the recording paper is nipped by the paper feed roller and thus reduces the feeding deviation of the recording paper during printing to perform an image print with high accuracy.

### DRAWINGS

FIG. 1 is a perspective view of an ink ribbon cassette according to a preferred emboidment;

FIG. 2 is a cross-sectional view of the ink ribbon cassette taken along line 2-2 of FIG. 1 when the ink ribbon cassette is mounted in a printer body; and

FIG. 3 is a view illustrating a printer body in which a conventional ribbon cassette is mounted.

### DESCRIPTION OF THE PREFERRED EMBODIMENTS

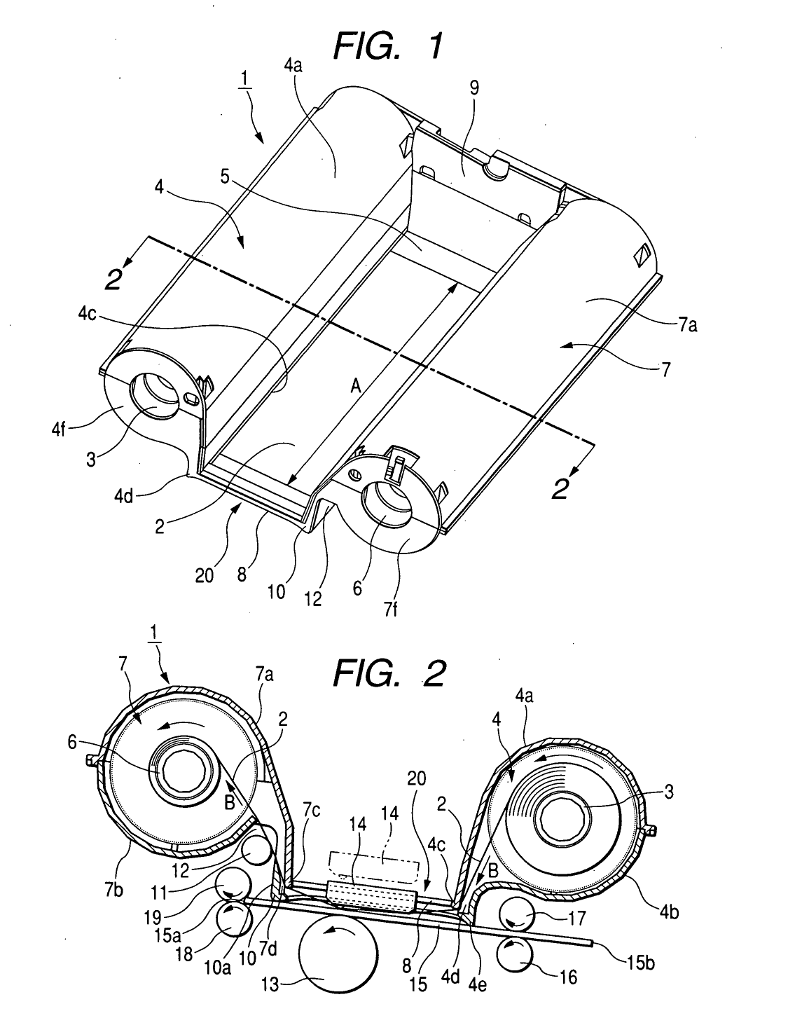

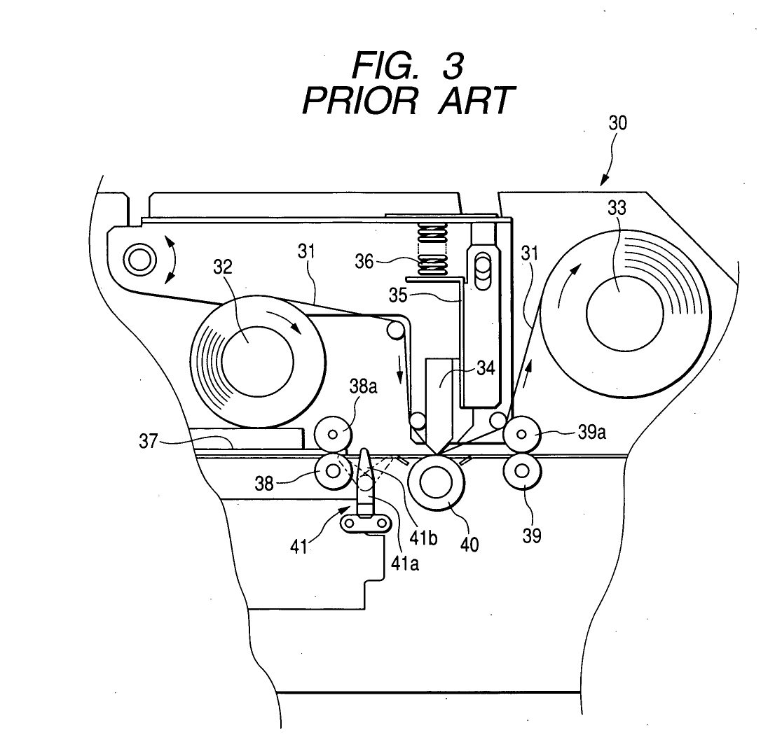

An ink ribbon cassette will be described with reference to the drawings. FIG. 1 is a perspective view of an ink ribbon cassette according to the invention, and FIG. 2 is a cross-sectional view of the ink ribbon cassette taken along line 2-2 of FIG. 1 when the ink ribbon cassette is mounted in a printer body.

The ink ribbon cassette 1 of a preferred embodiment is made of a resin material, and is provided with a first ribbon-receiving part 4 that receives a feeding reel 3 therein as shown in FIGS. 1 and 2. An unused ink ribbon 2 having a width of A is wound on the feeding reel 3.

The first ribbon-receiving part 4 includes a first wall 4a and a second wall 4b, which extend to have a substantially circular arc cross-section and have a cavity therein. A first ribbon-sliding portion 4c, with which the ink ribbon 2 to be wound on a take-up reel 6 to be described below can come in sliding contact, is formed at the lower end of the first wall 4a.

A ribbon outlet 4d, which is composed of a gap having a predetermined size, is provided outside the first ribbon-sliding portion 4c such that the ink ribbon 2 can pass through the ribbon outlet.

For example, the ribbon outlet 4d, through which the ink ribbon 2 wound on the feeding reel 3 can pass, is provided near the first ribbon-receiving part 4 in a head insertion opening 5.

The ribbon outlet 4d is defined by a first paper guide 4e, which is formed by protruding the lower end of the second wall 4b downward so as to extend along the first ribbon-sliding portion 4c. The front side of the hollow first ribbon-receiving part 4 shown in FIG. 1 is covered with a first sidewall 4f.

The ink ribbon cassette is provided with a second ribbon-receiving part 7 that receives the take-up reel 6 therein so that the first ribbon-receiving part 4 and the second ribbon-receiving part 7 face each other with a head insertion opening 5 interposed therebetween. The second ribbon-receiving part 7 includes a first wall 7a and a second wall 7b, which extend to have a substantially circular arc cross-section and have a cavity therein,

A second ribbon-sliding portion 7c, with which the ink ribbon 2 wound on the take-up reel 6 can come in sliding contact, is formed at the lower end of the first wall 7a.

A ribbon winding opening 7d, which is composed of a gap having a predetermined size, is provided outside the second ribbon-sliding portion 7c such that the ink ribbon 2 can pass through the winding opening.

For example, the ribbon winding opening 7d, through which the ink ribbon 2 to be wound on the take-up reel 6 can pass, is provided near the second ribbon-receiving part 7 in the head insertion opening 5.

The ribbon winding opening 7d is defined by a second paper guide 10, which is provided outside the second ribbon-sliding portion with a predetermined gap between the second paper guide and the second ribbon-sliding portion, such that the ink ribbon 2 can pass through the winding opening. The front side of the hollow second ribbon-receiving part 7 shown in FIG. 1 is covered with a second sidewall 7f.

The head insertion opening 5 is provided between the first walls 4a and 7a, which face each other, of the first and second ribbon-receiving parts 4 and 7.

The first sidewall 4f and the second sidewall 7f shown in FIG. 1 are connected to each other by a crosspiece 8 on the front side of the ink ribbon cassette, and the rear sides of the first and second ribbon-receiving parts 4 and 7 are connected to each other by a connecting member 9. The first and second ribbon-receiving parts 4 and 7, which face each other with the head insertion opening 5 interposed therebetween, are unified.

The ribbon winding opening 7d, which is composed of a gap having a predetermined size, is provided outside the second ribbon-sliding portion 7c, which is formed at the lower end of the first wall 7a of the second ribbon-receiving part 7, such that the ink ribbon 2 can pass through the ribbon winding opening.

For example, the ribbon winding opening 7d, through which the ink ribbon 2 drawn through the ribbon outlet 4d can pass to be wound on the take-up reel 6, is provided near the second ribbon-receiving part 7 in the head insertion opening 5.

The ribbon winding opening 7d, which is composed of a gap having a predetermined size, is provided outside the second ribbon-sliding portion 7c, which is formed at the lower end of the first wall 7a of the second ribbon-receiving part 7 (such that the ink ribbon 2 can pass through the ribbon winding opening).

For example, the ribbon winding opening 7d, through which the ink ribbon 2 drawn through the ribbon outlet 4d can pass to be wound on the take-up reel 6, is provided near the second ribbon-receiving part 7 in the head insertion opening 5.

The second paper guide 10 extending along the second ribbon-sliding portion 7c is provided outside the ribbon winding opening 7d, which is composed of a gap having a predetermined size.

While being fed, a recording paper 15 to be described below can be guided by the second paper guide 10. The ink ribbon 2 passing through the ribbon winding opening 7d can also be guided by the second paper guide 10.

The ink ribbon 2, which slides on the second ribbon-sliding portion 7c and is wound on the take-up reel 6, is guided by a guide roller 11 provided to a printer body (not shown) and can be wound on the take-up reel 6.

The second ribbon-receiving part 7 is provided with an escape portion 12 for the guide roller 11. The ink ribbon 2, which is guided by the rotatable guide roller 11 positioned at the escape portion 12, can be wound on the take-up reel 6, and can be wound in a direction indicated by an arrow B.

The printer body (not shown), in which the ink ribbon cassette 1 of the invention is mounted, is provided with a platen roller 13 below the crosspiece 8 of the ink ribbon cassette 1. The platen roller 13 is rotated depending on the rotation of a first paper feed roller 16. A thermal head 14, which can approach and be separated from (head up/down) the platen roller 13, is disposed on the upper side of the platen roller 13 so as to face the platen roller 13.

As shown in FIG. 2, the recording paper 15 is disposed between the platen roller 13 and the thermal head 14 together with the ink ribbon 2. For example, the recording paper 15 is disposed on the platen roller 13 so that the ink ribbon 2 is disposed between the thermal head 14 and the recording paper 15. The recording paper 15 is composed of a heavy paper such as a photographic paper used for color printing, and can be fed on the platen roller 13 from the right side (upstream) to the left side (downstream) in FIG. 2.

For example, the recording paper 15 is disposed between the platen roller 13 and the thermal head 14 so as to be fed in a direction (indicated by the arrow B) in which the ink ribbon 2 is wound, or in the reverse direction.

The thermal head 14 before printing is in a head up state as shown by a two-dot chain line, and the thermal head 14 during printing moves down to a position shown by a solid line so as to press the recording paper 15 and the ink ribbon 2 against the platen roller 13.

A first paper feed roller 16 and a first press roller 17 are provided to the printer body (not shown) near the first paper guide 4e of the ink ribbon cassette 1. The first paper feed roller 16 and the first press roller 17 press the recording paper 15 therebetween, and can feed the recording paper 15 to the downstream.

A second paper feed roller 18 and a second press roller 19 are provided near the second paper guide 10. The second paper feed roller 18 and the second press roller 19 press the front end 15a of the recording paper 15, which is fed to the downstream by the first paper feed roller 16 and the first press roller 17, therebetween.

The front end 15a of the recording paper 15, which is fed to the downstream by the first paper feed roller 16 and the first press roller 17, is guided by the second paper guide 10. The rear end 15b of the recording paper 15, which is fed to the upstream by the second paper feed roller 18 and the second press roller 19, is guided by the first paper guide 4e.

As a result, while the thermal head 14 moves up, the bend of the recording paper 15 during printing is corrected. Accordingly, the recording paper 15 is fed in the flat shape.

A printing operation will be described with reference to FIG. 2. After the ink ribbon cassette 1, which has the above-mentioned structure, according to a preferred eembodiment is mounted in the printer body of a thermal transfer printer, the printing operation is performed. A paper cassette (not shown), in which a plurality of recording papers 15 having a predetermined size is received, is provided on the right side of the first paper feed roller 16 in FIG. 2. Each recording paper 15, which is separated from the paper cassette one by one by means of a pickup roller, is fed to the left side (downstream) in FIG. 2, and the front end 15a of the recording paper 15 is then pressed and held between the first paper feed roller 16 and the first press roller 17. The first paper feed roller 16 is rotated by the torque generated by a driving source such as a motor, and the torque is transmitted from the platen roller 13 to the second paper feed roller 18 by a connecting gear.

For example, when the recording paper 15 is fed to the downstream, the first paper feed roller 16, the platen roller 13, and the second paper feed roller 18 are rotated in the counterclockwise direction.

When the first paper feed roller 16 is rotated in the counterclockwise direction, the front end 15a of the recording paper 15 is pressed and held between the thermal head 14, which is in a head down state, and the platen roller 13. The front end 15a of the recording paper 15 is detected by a paper detecting sensor (not shown), and the front end of the recording paper 15 is advanced.

With the advance of the front end of the recording paper 15, several heating elements of the thermal head 14 selectively generate heat on the basis of printing information, to transfer a first color ink of the ink ribbon 2 onto the recording paper 15, which is fed to the downstream, from the front end 15a thereof. In this way, a first printing operation starts.

Even though the front end 15a of the recording paper 15 during the printing operation is bent slightly upward due to the heat or contact pressure of the thermal head 14, the front end 15a of the recording paper 15, which is fed to the downstream, is guided by the second paper guide 10. Accordingly, it is possible to smoothly lead the front end 15a of the recording paper 15 to between the second paper feed roller 18 and the second press roller 19.

The recording paper 15 during the first printing operation is fed to the downstream in the flat shape.

The rear end 15b of the recording paper 15 during the first printing operation escapes from the first paper feed roller 16 and the first press roller 17, which come in press contact with each other, and the recording paper is then fed to the downstream. When the rear end 15b of the recording paper 15 escapes from the pressing by the heating portion of the thermal head 14, a first color image is printed on the entire recording paper 15.

When the front end 15a of the recording paper 15 is detected by the paper detecting sensor (not shown), the thermal head 14 moves up and the first paper feed roller 16, the platen roller 13, and the second paper feed roller 18 are rotated clockwise. After the first printing operation has been completed, the recording paper 15 is back fed to the right side (upstream) in FIG. 2.

When the paper detecting sensor detects the front end 15a of the recording paper 15, the thermal head 14 moves down and the first paper feed roller 16, the platen roller 13, and the second paper feed roller 18 are rotated in the counterclockwise direction.

A second printing operation is performed such that a second color image is overprinted on the first color image printed through the first printing operation.

The same operation is repeated such that a third color image is overprinted on the second color image by repeating a third printing operation. Accordingly, it is possible to print a desired color image on the recording paper 15.

The ink ribbon cassette 1 includes the first and second paper guides 4e and 10. Even though a trouble such as a bend occurs on the recording paper 15, it is possible to smoothly lead the recording paper between the paper feed roller and the press roller. It is possible to perform an image print with high accuracy by reducing the deviation of the timing in which the recording paper is nipped by the paper feed roller.

A head insertion opening, into which a thermal head is inserted, is formed between a first and second ribbon-receiving parts of an ink ribbon cassette according to the invention, and the thermal head can approach and be separated from (head up/down) a platen roller provided to a printer body. A ribbon outlet, through which the ink ribbon wound on the feeding reel passes, is provided near the first ribbon-receiving part in the head insertion opening. A ribbon winding opening, through which the ink ribbon drawn through the ribbon outlet passes to be wound on the take-up reel, is provided near the second ribbon-receiving part in the head insertion opening. A first paper guide is provided at the ribbon outlet and a second paper guide is provided at the ribbon winding opening so that a recording paper to be fed is guided by the first and second paper guides. The shape of a recording paper, which is bent due to the heat or contact pressure of the thermal head, is corrected to the flat shape. As a result, it is possible to reduce the deviation of the timing in which the recording paper is nipped by a paper feed roller.

Since the feeding deviation of the recording paper is reduced, it is possible to perform an image print with high accuracy even when colors for color printing are overprinted on the recording paper.

In addition, the recording paper is disposed between the platen roller and the thermal head, which are provided to the printer body, so as to be fed in a direction in which the ink ribbon is wound, or in the reverse direction. When the ink ribbon cassette is mounted in the printer body and the thermal head moves down and the recording paper is printed while being fed to the downstream, the front end of the recording paper is guided by the second paper guide. Furthermore, when the thermal head moves up and the recording paper is back fed to the upstream, the rear end of the recording paper is guided by the first paper guide. Therefore, even when the recording paper is fed during printing or is back fed during non-printing, it is possible to feed the recording paper with high accuracy.

When the ink ribbon cassette is mounted in the printer body, a first paper feed roller and a first press roller, which press the recording paper therebetween and feed the recording paper between the platen roller and the thermal head, are provided near the first paper guide, and a second paper feed roller and a second press roller are provided near the second paper guide such that the recording paper is fed to the upstream or downstream by the rotation of the first and second paper feed rollers. Accordingly, since it is possible to smoothly lead the recording paper guided by the first and second guides to the first and second paper feed rollers, it is possible to reduce the deviation of the timing in which the recording paper is nipped.

While being guided by the second paper guide, the front end of the recording paper, which is fed to the downstream during printing, is pressed and held between the second paper feed roller and the second press roller. As a result, after the advance of the front end of the recording paper, the rear end of the recording paper is guided by the second guide and can be pressed and held between the second paper feed roller and the second press roller.

The recoding paper, which is guided by the first and second paper guide, is fed in the flat shape.

Accordingly, it is possible to smoothly lead the rear end or the front end of the recording paper to the paper feed rollers.

1. An ink ribbon cassette comprising:
an ink ribbon;
a head insertion opening;
a first ribbon-receiving part; and
a second ribbon-receiving part,
the thermal head approaches and is separated from a platen roller provided to a printer body, and is disposed in the head insertion opening,
a ribbon outlet is provided near the first ribbon-receiving part in the head insertion opening,
a ribbon winding opening is provided near the second ribbon-receiving part in the head insertion opening, and
a first paper guide is provided at the ribbon outlet and a second paper guide is provided at the ribbon winding opening so that a recording paper to be fed is guided by the first and second paper guides.

2. The ink ribbon cassette according to claim 1,
wherein the first ribbon-receiving part receives a feeding reel on which an unused portion of the ink ribbon is wound, and the second ribbon-receiving part receives a take-up reel on which a used portion of the ink ribbon is wound.

3. The ink ribbon cassette according to claim 1,
wherein the ink ribbon wound on the feeding reel passes through the ribbon outlet.

4. The ink ribbon cassette according to claim 3, wherein ink ribbon drawn through the ribbon outlet passes through the ribbon winding opening to be wound on the take-up reel.

5. The ink ribbon cassette according to claim 1,
wherein the recording paper is disposed between the platen roller and the thermal head, which are provided to the printer body, so as to be fed in a direction in which the ink ribbon is wound, or in the reverse direction,
when the ink ribbon cassette is mounted in the printer body and the thermal head moves down and the recording paper is printed while being fed to the downstream, the front end of the recording paper is guided by the second paper guide, and
when the thermal head moves up and the recording paper is back fed to the upstream, the rear end of the recording paper is guided by the first paper guide.

6. The ink ribbon cassette according to claim 5,
wherein when the ink ribbon cassette is mounted in the printer body, a first paper feed roller and a first press roller, which press the recording paper therebetween and feed the recording paper between the platen roller and the thermal head, are provided near the first paper guide, and a second paper feed roller and a second press roller are provided near the second paper guide such that the recording paper is fed to the upstream or downstream by the rotation of the first and second paper feed rollers.

7. The ink ribbon cassette according to claim 6,
wherein while being guided by the second paper guide, the front end of the recording paper, which is fed to the downstream during printing, is pressed and held between the second paper feed roller and the second press roller.

8. The ink ribbon cassette according to claim 5,
wherein the recoding paper, which is guided by the first and second paper guide, is fed in the flat shape.

9. An ink ribbon cassette comprising:
an ink ribbon;
a first ribbon-receiving part that receives a feeding reel on which an unused portion of the ink ribbon is wound; and
a second ribbon-receiving part that receives a take-up reel on which a used portion of the ink ribbon is wound,
wherein a head insertion opening, into which a thermal head is inserted, is formed between the first and second ribbon-receiving parts,
the thermal head approaches and is separated from (head up/down) a platen roller provided to a printer body,
a ribbon outlet, through which the ink ribbon wound on the feeding reel passes, is provided near the first ribbon-receiving part in the head insertion opening,
a ribbon winding opening, through which the ink ribbon drawn through the ribbon outlet passes to be wound on the take-up reel, is provided near the second ribbon-receiving part in the head insertion opening, and
a first paper guide is provided at the ribbon outlet and a second paper guide is provided at the ribbon winding opening so that a recording paper to be fed is guided by the first and second paper guides.

10. The ink ribbon cassette according to claim 9,
wherein the recording paper is disposed between the platen roller and the thermal head, which are provided to the printer body, so as to be fed in a direction in which the ink ribbon is wound, or in the reverse direction,
when the ink ribbon cassette is mounted in the printer body and the thermal head moves down and the recording paper is printed while being fed to the downstream, the front end of the recording paper is guided by the second paper guide, and
when the thermal head moves up and the recording paper is back fed to the upstream, the rear end of the recording paper is guided by the first paper guide.

11. The ink ribbon cassette according to claim 10,
wherein when the ink ribbon cassette is mounted in the printer body, a first paper feed roller and a first press roller, which press the recording paper therebetween and feed the recording paper between the platen roller and the thermal head, are provided near the first paper guide, and a second paper feed roller and a second press roller are provided near the second paper guide such that the recording paper is fed to the upstream or downstream by the rotation of the first and second paper feed rollers.

12. The ink ribbon cassette according to claim 11,
wherein while being guided by the second paper guide, the front end of the recording paper, which is fed to the downstream during printing, is pressed and held between the second paper feed roller and the second press roller.

13. The ink ribbon cassette according to claim 10,
wherein the recoding paper, which is guided by the first and second paper guide, is fed in the flat shape.
